(19) United States
(12) Patent Application Publication
(10) Pub. No.: US 2026/0109174 A1
(43) Pub. Date: Apr. 23, 2026

(54) WHEEL DRIVE DEVICE

(71) Applicants: Hyundai Motor Company, Seoul (KR); Kia Corporation, Seoul (KR)

(72) Inventor: Sang Woo Hwang, Hwaseong-si (KR)

(21) Appl. No.: 19/191,576

(22) Filed: Apr. 28, 2025

(30) Foreign Application Priority Data
Oct. 23, 2024 (KR) 10-2024-0145620

(51) Int. Cl. B60B 19/00; B60B 19/12; B60K 7/00; B60K 17/04; F16H 1/22; F16H 7/06

(52) U.S. Cl. CPC B60B 19/003; B60B 19/12; B60K 7/0007; B60K 17/043; F16H 1/222; F16H 7/06

(57) ABSTRACT

In accordance with an embodiment, a device includes: a mounting structure configured to be connected to a vehicle body; a first drive shaft configured to be rotatably supported by a mounting structure; a second drive shaft rotatably supported by the first drive shaft; a wheel body fixed to the first drive shaft, the wheel body being configured to rotate simultaneously with the first drive shaft; a wheel unit rotatably supported by the wheel body; and a gear unit connected to the second drive shaft, the gear unit being configured to transmit rotational force from the second drive shaft to the wheel unit.

### CROSS-REFERENCE TO RELATED APPLICATIONS

This application claims, under 35 U.S.C. § 119(a), the benefit of priority from Korean Patent Application No. 10-2024-0145620, filed on Oct. 23, 2024, the entire contents of which are incorporated herein by reference.

### TECHNICAL FIELD

The present disclosure generally relates to mechanical systems, and more particularly to a wheel drive device.

Relates to an omnidirectional rotation drive device, and more particularly, to an omnidirectional rotation drive device including a plurality of sub-wheels formed on the outer circumferential surface of a wheel body rotatable in a first direction and configured to be rotatable in a second direction.

### BACKGROUND

Recently, in the electric vehicle (EV) industry, research and development has been actively conducted on an omnidirectional wheel structure capable of driving on a flat surface without changing the steering angle. An omni wheel is also referred to as an omnidirectional movement wheel. That is, the omni wheel means a wheel capable of moving in all directions. The structure of the omni wheel enables various types of movement that may not be implemented by an ordinary wheel. For example, the omni wheel enables a transportation device to rotate in place, move horizontally to the left, and move horizontally to the right.

However, the conventionally developed omni-wheel structure has a problem in that, due to a discontinuous structure of a sub-wheel and low power transmission efficiency, the omni wheel may not be applied to a vehicle using the existing suspension structure.

The above information disclosed in this Background section is only for enhancement of understanding of the background of the disclosure, and therefore it may contain information that does not form the prior art as defined by the patent statute.

### SUMMARY

Some embodiments are directed to an omnidirectional rotation drive device configured to enable a vehicle to move in a first direction through a wheel body and to enable the vehicle to move in a second direction by selectively driving a sub-wheel.

Some embodiments provide an omnidirectional rotation drive device configured to selectively drive a sub-wheel by providing a gear unit located in a wheel body coupled to a first motor and coupled to a second motor.

Some embodiments related to an omnidirectional rotation drive device including a plurality of sub-wheels formed on the outer circumferential surface of a wheel body rotatable in a first direction and configured to be rotatable in a second direction.

In one aspect, the present disclosure provides an omnidirectional rotation drive device including a knuckle connected to a vehicle body, a first drive shaft rotatably supported by the knuckle, a second drive shaft rotatably supported by the first drive shaft, a wheel body fixed to the first drive shaft, the wheel body being configured to rotate simultaneously with the first drive shaft, a wheel unit rotatably supported by the wheel body, and a gear unit connected to the second drive shaft, the gear unit being configured to transmit rotational force from the second drive shaft to the wheel unit, wherein the wheel unit includes a chain part connected to the gear unit, the gear unit is rotated according to a difference between an angular velocity of the first drive shaft and an angular velocity of the second drive shaft, and the wheel unit is rotated in response to rotation of the gear unit.

In an embodiment, the wheel unit may include a plurality of sub-wheels, the chain part may be located between the two sub-wheels adjacent to each other, and rotation central axes of the plurality of sub-wheels may be configured to be perpendicular to a rotation central axis of the wheel body.

In another embodiment, the wheel unit may include a plurality of rigid parts configured to support a load and a connection part configured to connect the plurality of rigid parts to each other, and the chain part may be formed on the rigid part.

In still another embodiment, the omnidirectional rotation drive device may further include a first motor configured to rotate the first drive shaft and a second motor configured to rotate the second drive shaft.

In yet another embodiment, the gear unit may include a second gear connected to a first gear of the second drive shaft, a third gear meshed with the second gear, a fourth gear meshed with the third gear, and a sprocket located coaxially with the fourth gear and coupled to the chain part.

In still yet another embodiment, a rotation axis of the first gear and a rotation axis of the second gear may be parallel with each other, and a rotation axis of the third gear may be disposed to be perpendicular to the rotation axis of the first gear.

In a further embodiment, the omnidirectional rotation drive device may further include at least one sub-sprocket rotatably supported by the wheel body and coupled to the chain part.

In another further embodiment, the omnidirectional rotation drive device may further include a support part rotatably restrained to the wheel body, the support part being configured to rotatably support the wheel unit.

In still another further embodiment, only the wheel body may be rotatably driven when the first drive shaft and the second drive shaft are rotated at the same angular velocity.

In yet another further embodiment, the wheel body and the wheel unit may be rotatably driven simultaneously when the first drive shaft and the second drive shaft are rotated at different angular velocities or when the first drive shaft is rotated and the second drive shaft is stopped.

In still yet another further embodiment, only the wheel unit may be rotatably driven when the first drive shaft is stopped and the second drive shaft is rotated.

In a still further embodiment, the omnidirectional rotation drive device may further include a transmission unit connected to the gear unit inside the wheel body, the transmission unit being coupled to a chain part adjacent to the chain part coupled to the gear unit so as to apply drive force of the second drive shaft.

In a yet still further embodiment, the transmission unit may include an angle correction bevel gear coupled to a bevel gear located coaxially with the fourth gear, a first transmission gear located coaxially with the angle correction bevel gear, a second transmission gear meshed with the first transmission gear, and a second sprocket located coaxially with the second transmission gear and coupled to the chain part.

In a yet embodiment, the transmission unit may be located on at least one side surface of both side surfaces adjacent to the gear unit.

Other aspects and embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a front view of an omnidirectional rotation drive device according to an embodiment of the present disclosure;

FIG. 2 is a side cross-sectional view of the omnidirectional rotation drive device according to the embodiment of the present disclosure;

FIG. 3 is a side cross-sectional view of a coupling structure of a drive shaft of the omnidirectional rotation drive device according to the embodiment of the present disclosure;

FIG. 4 is a front view of an omnidirectional rotation drive device including a transmission unit according to another embodiment of the present disclosure;

FIGS. 5A, 5B and 5C are views each showing a driving relationship between a main wheel and a wheel unit according to the embodiment of the present disclosure; and

FIG. 6 is a view showing a configuration of a single wheel unit located on the outer circumferential surface of a wheel body according to another embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION OF ILLUSTRATIVE EMBODIMENTS

Hereinafter, reference will be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

Terms such as “part”, “unit”, and “module” described in the specification mean a unit configured to process at least one function or operation, and the unit may be implemented by hardware or software or a combination of hardware and software.

The terms used in the specification are merely used to describe specific embodiments and are not intended to limit the embodiments. Singular forms are intended to include plural forms as well, unless the context clearly indicates otherwise.

Meanwhile, in this specification, terms such as “first” and “second” are used to describe various components having the same names, and the terms are used only for the purpose of distinguishing one component from other components. The components are not limited by the terms in the following description.

In this specification, a first direction refers to a rotation direction of a wheel body. Further, a width direction of the wheel body, which is perpendicular to the first direction, is hereinafter referred to as a second direction.

In addition, in this specification, a configuration in which a sub-wheel and a wheel body are integrally rotated in a direction in which the wheel body is rotated may be interpreted as a main wheel, and a configuration in which the sub-wheel is rotated independently in the width direction of the wheel body may be interpreted as an auxiliary wheel.

Hereinafter, embodiments will be described in detail with reference to the accompanying drawings. In describing the embodiments with reference to the accompanying drawings, the same or corresponding components will be denoted by the same reference numerals and redundant description thereof will be omitted.

The present disclosure relates to an omnidirectional rotation drive device, and more particularly to, a drive device having an omni-structure capable of moving in all directions by providing a wheel body 20 rotatable in a first direction and a wheel unit 100 located along the outer circumferential surface of the wheel body 20 and rotated in a second direction. Here, the wheel unit 100 is a configuration including a plurality of sub-wheels 110 located in the same row.

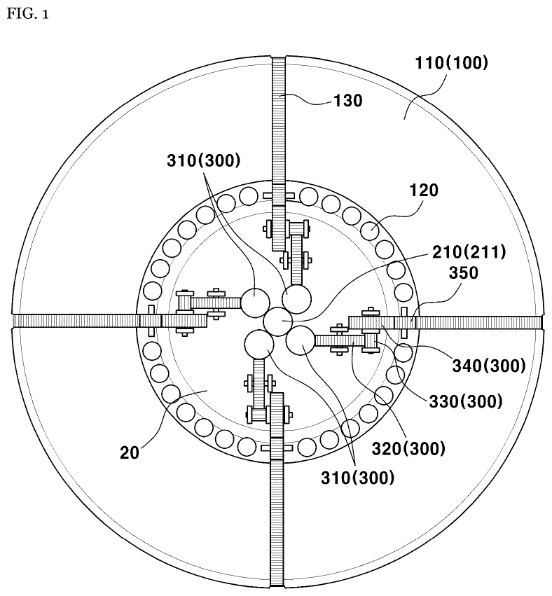

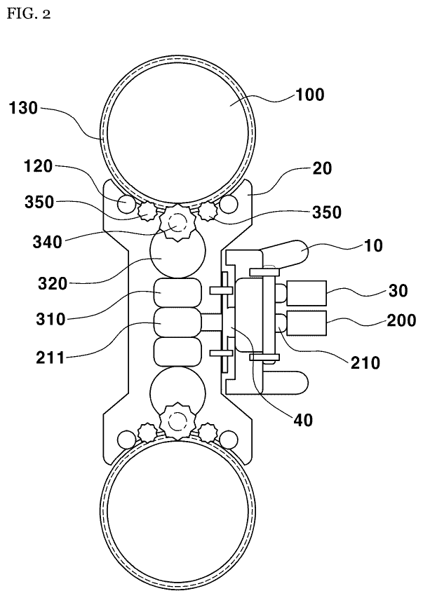

As shown in FIGS. 1 and 2, the omnidirectional rotation drive device of the present disclosure includes a knuckle 10, at least a part of which is disposed in a vehicle, and a first motor 30 located on the knuckle 10 with the knuckle 10 as the central axis thereof and configured to rotate the wheel body 20. The wheel body 20 may be located at one end of the knuckle 10, and the first motor 30 has a stator located in the knuckle 10 and a rotor integrally rotated with the wheel body 20. Further, a first drive shaft 40 coupled to the wheel body 20 is coupled to the first motor 30 on the inner peripheral side of the knuckle 10 so as to transmit drive force to the wheel body 20 through the first drive shaft 40.

In addition, in a state in which the stator of the first motor 30 is fixed to the vehicle body, when current is applied to rotate the first drive shaft 40 including a rotor, the rotor and the wheel body 20 are configured to be integrally rotated. Furthermore, the wheel body 20 is configured to be rotated in the first direction, and forward- and-rearward drive force of the vehicle is configured to be applied through the first motor 30. Therefore, the main wheel of the present disclosure may mean a direction in which the wheel body 20 is rotated by driving of the first motor 30.

The wheel body 20 may have the knuckle 10 located therethrough and may be coupled to the first motor 30 fixed to the vehicle body. The wheel unit 100 is configured to extend toward the outside of the outer circumferential surface of the wheel body 20 in the radial direction of the wheel body 20. Further, the wheel body 20 extends in the width direction thereof and is coupled to the wheel unit 100. The present disclosure includes the wheel unit 100 having a rotation shaft disposed in a direction perpendicular to the width direction of the wheel body 20, in which the rotation shaft is rotated by rotational force of a second drive shaft 210 located inside the wheel body 20. The wheel unit 100 is configured such that a plurality of sub-wheels 110 are mutually coupled to each other so as to enable rotation of the plurality of sub-wheels 110. The plurality of sub-wheels 110 may be located on the circular outer circumferential surface of the wheel body 20 and may be rotatably located in the width direction of the wheel body 20.

The wheel unit 100 may be configured such that, when the central shafts of the plurality of sub-wheels 110 are mutually coupled to each other and one sub-wheel 110 is rotated by the second drive shaft 210, all of the sub-wheels 110 may be integrally rotated. Furthermore, according to the embodiment, the number of sub-wheels 110 to which drive force is applied may be determined depending on the number of gear units 300 coupled to a first gear 211. As another embodiment, the number of sub-wheels 110 to which drive force is applied may be determined corresponding to the number of gear units 300 and transmission units 400.

In this manner, the wheel unit 100 includes a plurality of sub-wheels 110 in one row. In addition, when at least one sub-wheel 110 is rotated in a state in which the sub-wheels 110 are coupled to each other, all the sub-wheels 110 coupled to each other may be rotated in the width direction of the wheel body 20.

Further, a second motor 200 located in the vehicle body is coupled to the second drive shaft 210 penetrating the knuckle 10 and the first drive shaft 40, and drive force of the second motor 200 is transmitted to the wheel unit 100 through the gear unit 300 located between the second drive shaft 210 and the wheel unit 100.

At least four first gears 211 located on the second drive shaft 210 are configured to be disposed in the radial direction of the wheel body 20. The gear unit 300 may be configured with four gears extending from the wheel body 20, and four gear units may be located at intervals of 90 degrees from each other relative to the rotation central axis of the wheel body 20.

Furthermore, the second drive shaft 210 may include the first gear 211 located on the outer circumferential surface thereof. A gear part including the first gear 211 may be formed to be integrated with the second drive shaft 210, or the first gear 211 coupled to each of the second gears 310 may be positioned separately from the second drive shaft 210.

According to the embodiment of the present disclosure, the second drive shaft 210 includes the first gear 211 in the longitudinal direction thereof. In addition, the sub-wheels 110 coupled to the respective gear units 300 are configured to be adjacent to each other in the outer circumferential surface of the wheel body 20. Further, the sub-wheels 110 are located so as to be driven simultaneously through one gear unit 300.

The wheel unit 100 includes a plurality of sub-wheels 110 located on the outer circumferential surface of the wheel body 20 and configured to have a predetermined angle in the width direction. The wheel unit 100 includes a chain part 130 located between two sub-wheels 110 and coupled to a sprocket 340 of the gear unit 300. The chain part 130 is located between the plurality of sub-wheels 110 at a position corresponding to the gear unit 300. Therefore, the sub-wheel 110 is configured to be rotated by receiving drive force of the second drive shaft 210 from the sprocket 340 of the gear unit 300.

In this manner, the present disclosure includes a plurality of sub-wheels 110 located along the outer circumferential surface of the wheel body 20. When viewed from the side of the wheel body 20, the main wheel including the plurality of sub-wheels 110 has a continuous circle shape.

As shown in FIG. 2, a rotation shaft of the first motor 30 is coupled to the outer circumferential surface of the first drive shaft 40 so as to rotate the wheel body 20. Furthermore, the rotation shaft of the first motor 30 may include all of the connection relationships capable of transmitting drive force to the first drive shaft 40. For example, the rotation shaft of the first motor 30 and the first drive shaft 40 may include at least one power transmission structure among gear coupling, worm gear coupling, coupling using a bevel gear 360, a chain, and a belt.

The rotor of the second motor 200 is coupled to the second drive shaft 210 through the knuckle 10, and the second drive shaft 210 is configured to be rotatable independently of the first drive shaft 40.

Furthermore, the first drive shaft 40 located through the knuckle 10 is configured to enable the wheel body 20 to rotate independently of the knuckle 10 through a bearing located on the inner circumferential surface of the knuckle 10.

In this manner, the knuckle 10, the first drive shaft 40, and the second drive shaft 210 may include various types of bearings on the surfaces thereof contacting each other so as to be rotatable independently of each other.

Additionally, the gear unit 300 may include the first gear 211 located on the second drive shaft 210, the second gear 310 coupled to the first gear 211, a third gear 320 coupled to the second gear 310, a fourth gear 330 coupled to the third gear 320, and the sprocket 340 located coaxially with the fourth gear 330 and located between the fourth gear 330 and the chain part 130 of the wheel unit 100.

Here, the second gear 310 is configured as a helical gear and is configured to include a helix having a predetermined angle relative to the first gear 211 of the second drive shaft 210. Through this configuration, a rotation central shaft of the third gear 320 is converted into a state in which the rotation central shaft is rotated 90 degrees relative to a rotation central shaft of the second drive shaft 210.

The sprocket 340 is located coaxially with the fourth gear 330 and transmits drive force applied from the first gear 211 to the chain part 130. The chain part 130 is configured to be located between two sub-wheels 110 and to transmit drive force of the sprocket 340 to the sub-wheels 110 adjacent to the chain part 130.

At least one sub-sprocket 350 adjacent to the sprocket 340 in the rotation direction of the sub-wheel 110 may be configured to support the back surface of the sub-wheel 110. Accordingly, the chain part 130 and the sub-wheel 110 are configured to be aligned with each other through the sprocket 340 coupled to the chain part 130 and at least one sub-sprocket 350. The sprocket 340 and the sub-sprocket 350 may be coupled to each other or may be coupled to each other so as to be rotatable independently.

In addition, a support part 120 may be configured to support the sub-wheel 110 and located along the outer circumferential surface of the wheel body 20. The support part 120 may be configured in various forms. For example, at least one support part 120 may be located on the outer circumferential surface of the wheel body 20 and may have a degree of freedom in the rotation direction of the sub-wheel 110. As shown in FIGS. 1 and 2, the sub-sprockets 350 may be located adjacent to each other in the rotation direction of the sub-wheels 110 in which the sprockets 340 are respectively located, and the support part 120 located on the wheel body 20 is provided between the adjacent sprockets 340.

According to an embodiment of the present disclosure, the second drive shaft 210 includes gear areas of the first gears 211 located on the outer circumferential surface of the second drive shaft relative to the central axis of the second drive shaft, and four gear units 300 respectively coupled to the first gears 211. Each of the gear units 300 includes the second gear 310 coupled to a corresponding one of the first gears 211 of the second drive shaft 210, the third gear 320 coupled to the second gear 310, the sprocket 340 coupled to the chain part 130 located on the wheel unit 100, and the fourth gear 330 located coaxially with the sprocket 340 and coupled to the third gear 320.

The first gear 211 formed on the second drive shaft 210 is configured to form a worm gear and is located on the central axis of the second drive shaft 210. The first gear 211 is meshed with the second gear 310, and the rotation central axes thereof are arranged in parallel with each other. The second gear 310 may be formed as a helical gear having a spiral shape. The third gear 320 is configured to have a rotation axis rotated 90 degrees from the rotation center axes of the first gear 211 and the second gear 310.

The sprocket 340 is directly coupled to the chain part 130 formed between the adjacent sub-wheels 110 and is coupled to the fourth gear 330 located on the coaxial axis of the sprocket 340. The sprocket 340 is inserted into the chain part 130 located between the sub-wheels such that the chain part 130 is rotated in response to rotation of the sprocket 340.

Furthermore, the fourth gear 330, the third gear 320, and the sprocket 340 may be configured to have the rotation axes parallel with each other and may be configured to be orthogonal to the rotation axes of the first gear 211 and the second gear 310. In this manner, the gear unit 300 performs a function of changing rotational force of the second drive shaft 210 by 90 degrees and transmitting the same to the sprocket 340. Further, drive force applied to the sub-wheel 110 may be controlled by controlling the size, number of gears, and radius of gears constituting the first gear 211 of the second drive shaft 210 and the gear unit 300.

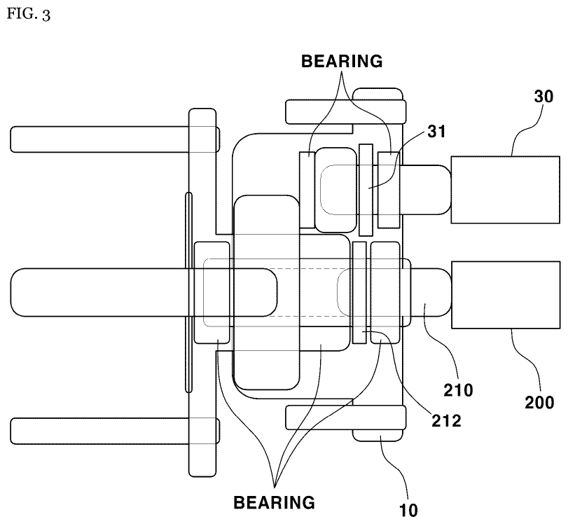

FIG. 3 is a side cross-sectional view of the omnidirectional rotation drive device according to the embodiment of the present disclosure.

As shown in FIG. 3, the omnidirectional rotation drive device includes the knuckle 10 fixed to the vehicle body, the first drive shaft 40 located through the knuckle 10, and the second drive shaft 210 located through the center of the knuckle 10.

The first drive shaft 40 is configured to be coupled to the first motor 30 and to be integrally rotated with the wheel body 20. The second drive shaft 210 is coupled to the second motor 200 through the central axis of the knuckle 10. Furthermore, the second drive shaft 210 may be located to extend toward the inside of the wheel body 20 through the central axis of the first drive shaft 40.

The first motor 30 and the second motor 200 may be located adjacent to each other on the inner surface of the knuckle 10, the central axis of the second motor 200 is directly coupled to the second drive shaft 210, and the first motor 30 is coupled to the first drive shaft 40 in a state in which the central axis of the first motor is eccentric with respect to the central axis of the first drive shaft so as to apply drive force of the first motor 30 to the first drive shaft 40.

The rotor of the first motor 30 is located on the inner side of the knuckle and is coupled to the first drive shaft 40, and the rotation speed applied from the first motor may be measured through a first sensor 31 located on the rotor of the first motor 30. In addition, the second motor 200 is coupled to the second drive shaft 210 located through the first drive shaft 40 and is configured to measure the rotation speed applied from the second motor 200 to the second drive shaft 210 through a second sensor 212 located adjacent to the rotor of the second motor 200.

A vehicle controller may receive a driving direction request from a user and control the rotation speeds of the first motor 30 and the second motor 200.

The knuckle 10, the first drive shaft 40, and the second drive shaft 210 may perform rotation thereof without interference with adjacent configurations through a plurality of bearings in the areas adjacent to each other.

The second drive shaft 210 coupled to the second motor 200 extends through the first drive shaft 40 and is inserted into the wheel body 20. Further, the second drive shaft includes the first gear 211. The first gears 211 formed on the outer circumferential surface of the second drive shaft 210 are configured to be coupled to the respective gear units 300 so as to transmit rotational force to the wheel unit 100. The four gear units 300 may be respectively coupled to the outer circumferential surfaces of the first gears 211 and are configured to transmit drive force of the second drive shaft 210 to the respective chain parts 130 located in the wheel unit 100.

The gear unit 300 includes the second gear 310 coupled to the first gear 211 of the second drive shaft 210, the third gear 320 coupled to the second gear 310, the sprocket 340 coupled to the respective sub-wheels 110, and the fourth gear 330 located coaxially with the sprocket 340 and coupled to the third gear 320.

Therefore, when the second drive shaft 210 is rotated by rotational force of the second motor 200, the gear unit 300 coupled to the first gear 211 applies rotational force to the sub-wheel 110, and the sub-wheel 110 is configured to be rotated in the second direction, which is a central axis formed in the tangential direction of the outer circumferential surface of the wheel body 20. The sub-wheel 110 may have both ends respectively including the chain parts 130 coupled to the respective gear units 300 such that drive force of the second drive shaft 210 is applied to the respective sub-wheels 110.

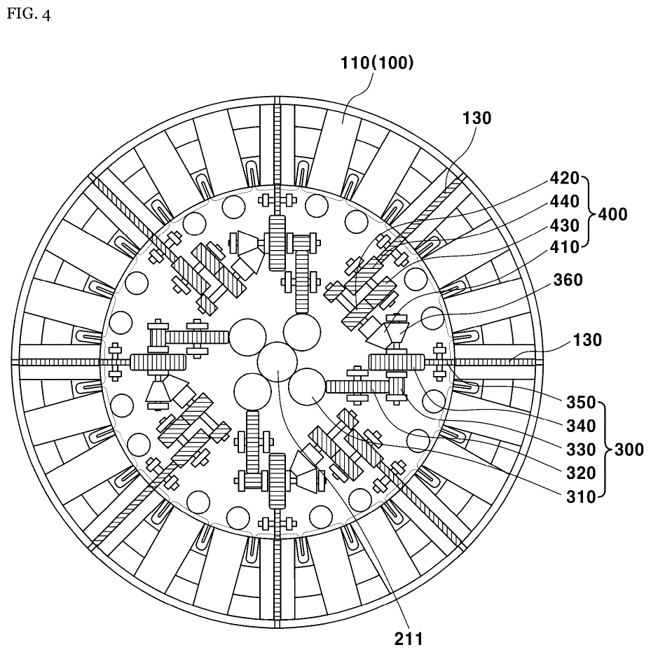

FIG. 4 is a view showing an omnidirectional rotation drive device according to another embodiment of the present disclosure. In the omnidirectional rotation drive device, drive force is transmitted to a sub-wheel 110 through a transmission unit 400 located adjacent to a gear unit 300 and the same drive force is also transmitted to another adjacent sub-wheel 110.

As shown in the drawing, according to another embodiment of the present disclosure, a second drive shaft 210 is inserted into a wheel body 20 through a first drive shaft 40, and the inserted second drive shaft 210 is configured to contact the gear unit 300 at at least one position. For example, the omnidirectional rotation drive device is formed of the second drive shaft 210 including a first gear 211 and four gear units 300 located at intervals of 90 degrees.

Here, each of the gear units 300 includes a second gear 310 that contacts the first gear 211, a third gear 320 that contacts the second gear 310, and a fourth gear 330 that contacts the third gear 320 and is located coaxially with a sprocket 340 coupled to a chain part 130 of the wheel unit 100.

In addition, the omnidirectional rotation drive device may include the transmission unit 400 located coaxially with the sprocket 340 and the fourth gear 330, and at least one of the transmission units 400 is located on the side surface of the sprocket 340 or the side surface of the fourth gear 330. For example, the transmission unit 400 includes a bevel gear 360 protruding from the side surface of the sprocket 340 coupled to the gear unit 300, and an angle correction bevel gear 410 coupled to the bevel gear 360. The angle correction bevel gear 410 is configured to be located coaxially with a first transmission gear 420 so as to rotate, by a set angle, rotational force applied to the bevel gear 360 extending from the side surface of the sprocket 340. In addition, the omnidirectional rotation drive device includes a second transmission gear 430 coupled to the first transmission gear 420 and a second sprocket 440 located coaxially with the second transmission gear 430.

The first transmission gear 420, the second transmission gear 430, and the second sprocket 440 are located inside the wheel body 20 so as to have a rotation axis in the same direction as the rotation axis of the sub-wheel 110 coupled to the second sprocket 440. Therefore, the sub-wheel 110 rotated through the gear unit 300 and the adjacent sub-wheel 110 coupled to the transmission unit 400 are simultaneously rotated. Additionally, the omnidirectional rotation drive device includes at least one sub sprocket 350 extending from the sprocket 340 in the width direction of the wheel body 20, and the sprocket 340 is configured to be coupled to the chain part 130 of the wheel unit 100 through the sub sprocket 350.

In this manner, according to another embodiment of the present disclosure, the omnidirectional rotation drive device includes four transmission units 400 respectively corresponding to the four gear units 300 such that the same drive force is transmitted to four sub-wheels 110 coupled to the gear unit 300 and the other sub-wheels 110 coupled to four adjacent transmission units 400. Eight sub-wheels may be configured to simultaneously receive rotational force applied from the second drive shaft 210.

In addition, a support part 120 is located at an area of the wheel body 20 facing the sub-wheel where the gear unit 300 and the transmission unit 400 are not located so as to avoid interference with the gear unit 300 and the transmission unit 400. Therefore, even when drive force is applied to a plurality of sub-wheels 110, all the sub-wheels 110 that are mutually coupled to each other in the width direction of the wheel body 20 may be rotated.

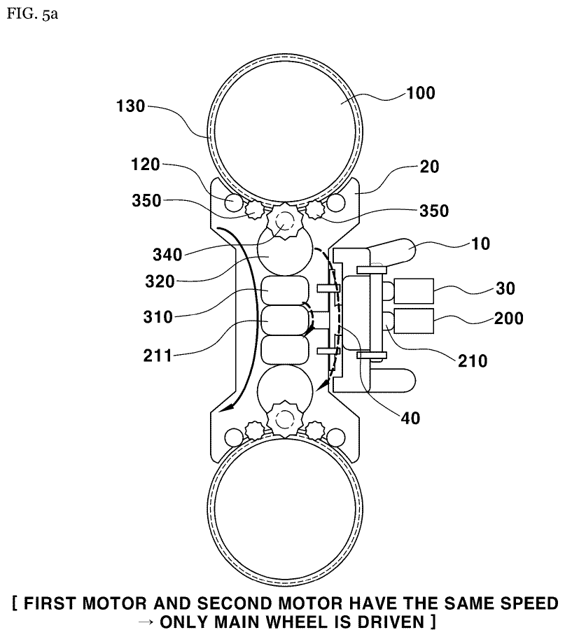

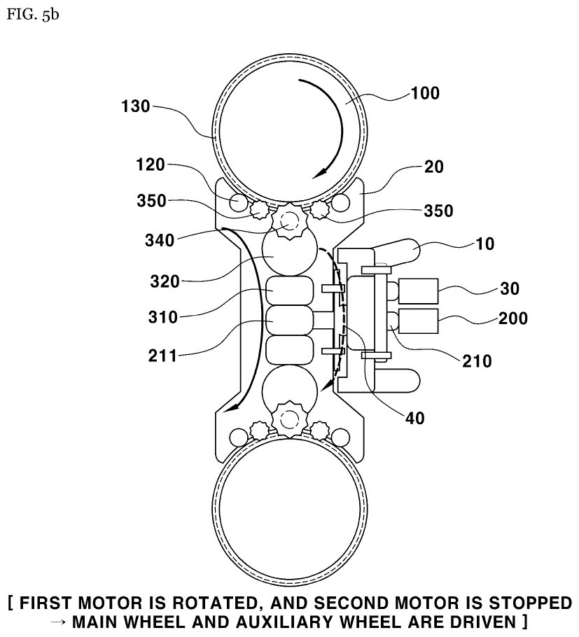

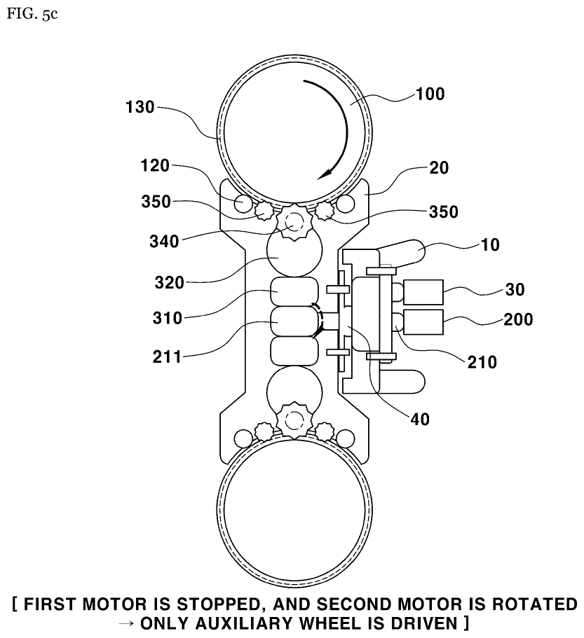

FIGS. 5A to 5C are views each showing a driving relationship between a main wheel (wheel body 20) and/or an auxiliary wheel (wheel unit 100) according to a difference in angular velocity between a first motor and a second motor.

As shown in FIG. 5A, when the first motor and the second motor are rotated to have the same angular velocity, the rotation speeds of a first drive shaft and a second drive shaft are the same, and accordingly, only the wheel body 20 is driven according to the angular velocity of the first motor.

In addition, as shown in FIG. 5B, when the first motor and the second motor have different angular velocities, the wheel body 20 is rotated according to the angular velocity of the first motor, and the wheel unit is controlled to have a rotation speed based on a difference in angular velocity between the first motor and the second motor.

That is, when the angular velocities of the first motor and the second motor are different from each other, a driving path having a predetermined angle may be set based on the rotation direction of the wheel body 20.

Finally, as shown in FIG. 5C, when the second motor has a predetermined angular velocity in a state in which the first motor is not driven, the wheel unit is configured to have a rotation speed of the angular velocity of the second motor. Furthermore, the omnidirectional rotation drive device may be driven to the right or left of the drawing according to the rotation direction of the second motor.

In addition, the wheel unit driven as shown in FIGS. 5B and 5C may be configured to be rotated along both sides of the wheel body 20 according to the number of gears of the gear unit 300 and the driving direction of the second motor.

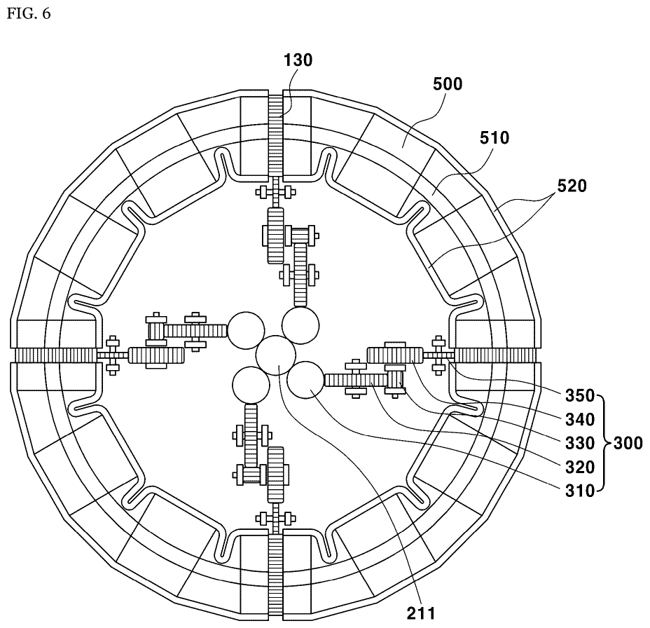

FIG. 6 shows an omnidirectional rotation drive device configured to wrap the outer circumferential surface of the wheel body with a single wheel unit, as another embodiment of the present disclosure.

As shown in FIG. 6, the omnidirectional rotation drive device includes all of the structural features shown in FIGS. 1 to 4, and may include a wheel unit having a single structure. That is, the wheel unit includes a plurality of rigid parts 500 spaced apart from each other along the outer circumferential surface of the wheel body unit, and connection parts 510 formed to penetrate the rotation central axes of the rigid parts 500 so as to connect the rigid parts to each other. The connection parts 510 are configured to be constrained from each other so as to integrally rotate the rigid parts 500 constituting the wheel unit.

A gear unit 300 coupled to a second drive shaft 210 is coupled to a chain part 130 located at the rigid part 500 such that the second drive shaft 210 applies rotational force to one chain part 130 located at at least one of the rigid parts 500 in response to the rotational force. The omnidirectional rotation drive device may include a coated fabric 520 configured to wrap the rigid parts and may be rotated in contact with the ground through a tire on the outer surface of the coated fabric 520.

That is, a plurality of rigid parts 500 is integrally wrapped by the coated fabric 520, and the single wheel unit is configured to be rotated in the width direction of the wheel body 20 according to driving of the second drive shaft in a state of being in contact with the road surface of the vehicle.

As is apparent from the above description, the present disclosure may achieve the following effects by the configuration, combination, and use relationship described in the embodiments.

The present disclosure provides an omnidirectional rotation drive device including a gear unit coupled to the inside of a wheel body, in which the omnidirectional rotation drive device has an effect of applying drive force to a chain part of a wheel unit.

Additionally, the driving direction of a vehicle is freely and selectively set through the omnidirectional rotation drive device having an omni-wheel structure capable of being driven in the first direction and/or the second direction.

Furthermore, the omnidirectional rotation drive device may apply drive force to a plurality of sub-wheels using the gear unit and a transmission unit located inside the wheel body, thereby having an effect of enabling compact design of the drive device.

The present disclosure has been described in detail with reference to embodiments thereof, and the present disclosure may be used in various other combinations, modifications, and environments. That is, it will be appreciated by those skilled in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A device comprising:
a mounting structure configured to be connected to a vehicle body;
a first drive shaft configured to be rotatably supported by a mounting structure;
a second drive shaft rotatably supported by the first drive shaft;
a wheel body fixed to the first drive shaft, the wheel body being configured to rotate simultaneously with the first drive shaft;
a wheel unit rotatably supported by the wheel body; and
a gear unit connected to the second drive shaft, the gear unit being configured to transmit rotational force from the second drive shaft to the wheel unit, wherein:
the wheel unit comprises a chain part connected to the gear unit, and
the gear unit is configured to be rotated according to a difference between an angular velocity of the first drive shaft and an angular velocity of the second drive shaft, and the wheel unit is configured to be rotated in response to rotation of the gear unit.

2. The device of claim 1, wherein:
the wheel unit comprises a plurality of sub-wheels;
the chain part is located between two sub-wheels of the plurality of sub-wheels adjacent to each other; and
rotation central axes of the plurality of sub-wheels are configured to be perpendicular to a rotation central axis of the wheel body.

3. The device of claim 1, wherein:
the wheel unit comprises a plurality of rigid parts configured to support a load, and a connection part configured to connect the plurality of rigid parts to each other; and
the chain part is disposed on the rigid part.

4. The device of claim 1, wherein the gear unit comprises:
a second gear connected to a first gear of the second drive shaft;
a third gear meshed with the second gear;
a fourth gear meshed with the third gear; and
a sprocket located coaxially with the fourth gear and coupled to the chain part.

5. The device of claim 4, wherein:
a rotation axis of the first gear and a rotation axis of the second gear are parallel with each other, and
a rotation axis of the third gear is perpendicular to the rotation axis of the first gear.

6. The device of claim 4, further comprising at least one sub-sprocket rotatably supported by the wheel body and coupled to the chain part.

7. The device of claim 1, further comprising a support part rotatably restrained to the wheel body, the support part being configured to rotatably support the wheel unit.

8. The device of claim 1, wherein the wheel body is configured to be rotatably driven and the wheel unit is configured to be rotatably fixed when the first drive shaft and the second drive shaft are rotated at the same angular velocity.

9. The device of claim 1, wherein the wheel body and the wheel unit are configured to be rotatably driven simultaneously when the first drive shaft and the second drive shaft are rotated at different angular velocities or when the first drive shaft is rotated and the second drive shaft is stopped.

10. The device of claim 1, wherein the wheel unit is configured to be rotatably driven and the wheel body is configured to be rotatably fixed when the first drive shaft is stopped and the second drive shaft is rotated.

11. The device of claim 1, further comprising:
a first motor configured to rotate the first drive shaft; and
a second motor configured to rotate the second drive shaft.

12. The device of claim 11, further comprising a transmission unit connected to the gear unit inside the wheel body, the transmission unit being coupled to a chain part adjacent to the chain part coupled to the gear unit and configured to apply a drive force of the second drive shaft.

13. The device of claim 12, wherein
the gear unit comprises:
a second gear connected to a first gear of the second drive shaft,
a third gear meshed with the second gear,
a fourth gear meshed with the third gear, and
a sprocket located coaxially with the fourth gear and coupled to the chain part; and
the transmission unit comprises:
an angle correction bevel gear coupled to a bevel gear located coaxially with the fourth gear,
a first transmission gear located coaxially with the angle correction bevel gear,
a second transmission gear meshed with the first transmission gear, and
a second sprocket located coaxially with the second transmission gear and coupled to the chain part.

14. The device of claim 12, wherein the transmission unit is located on at least one side surface of the gear unit.

15. The device of claim 1, further comprising the mounting structure.

16. The device of claim 15, wherein the mounting structure comprises a knuckle.

17. A method, comprising:
selectively operating a first drive shaft and a second drive shaft rotatably supported by the first drive shaft, selectively operating comprising:
rotating a wheel body fixed to the first drive shaft and keeping a wheel unit supported by the wheel body rotatably fixed in response to the first drive shaft and the second drive shaft being rotated at equal angular velocities, and
rotating the wheel body and rotating the wheel unit simultaneously in response to the first drive shaft and the second drive shaft being operated at rotated at different angular velocities or in response to the first drive shaft being rotated and the second drive shaft being stopped, wherein rotating the wheel unit comprises transmitting a rotational force from the second shaft to the wheel unit via a gear unit connected to a chain part of the wheel unit.

18. The method of claim 17, wherein transmitting the rotational force from the second shaft to the wheel unit via the gear unit comprises:
transferring the rotational force from a first gear of the second drive shaft to a second gear arranged parallel to the first gear;
transferring the rotational force from the second gear to a third gear arranged perpendicular to the first gear; and
transferring the rotational force from the third gear to a sprocket coupled to the chain part through a fourth gear arranged coaxially with the sprocket.

19. The method of claim 17, further comprising:
rotating a plurality of sub-wheels of the wheel unit around respective rotation axes; and
transmitting the rotational force through the chain part between two adjacent sub-wheels of the plurality of sub-wheels, wherein the rotation of the plurality of sub-wheels is maintained in a direction perpendicular to a direction of rotation of the wheel body.

20. A device comprising:
a rotatable wheel body having an outer circumferential surface;
a plurality of sub-wheels arranged around the outer circumferential surface of the wheel body, each sub-wheel configured to rotate around a respective rotation axis perpendicular to a rotation axis of the wheel body;
a first motor and a first drive shaft configured to rotate the wheel body around its rotation axis;
a second motor and a second drive shaft configured to selectively rotate the sub-wheels around their respective rotation axes, wherein the second drive shaft extends through a center of the wheel body, and the second drive shaft comprises a plurality of first gears;
a plurality of gear units arranged radially within the wheel body, each gear unit comprising a second gear coupled to at least one of the plurality of first gears of the second drive shaft, a third gear meshed with the second gear, a fourth gear meshed with the third gear, and a sprocket located coaxially with the fourth gear; and
a plurality of chain parts, each chain part connecting the sprocket of a respective gear unit to at least one of the sub-wheels.
